(19) United States
(12) Patent Application Publication
(10) Pub. No.: US 2014/0368349 A1
(43) Pub. Date: Dec. 18, 2014

(54) SENSORY ELEMENT PROJECTION SYSTEM AND METHOD OF USE

(71) Applicant: Revolution Display, Glendale, CA (US)

(72) Inventors: Claude OSTYN, Brugge (BE); Jeremy HOCHMAN, Glendale, CA (US)

(21) Appl. No.: 13/918,680

(22) Filed: Jun. 14, 2013

(51) Int. Cl. G08B 5/36

(52) U.S. Cl. CPC G08B 5/36
USPC 340/815.45

(57) ABSTRACT

Disclosed is an electromagnetic signal projector configured to transmit a pixelated signal across a projection field. The electromagnetic signal projector includes a transmitter configured to transmit a pixelated signal across a projection field and a plurality of individual sensory modules, where each sensory module includes at least one sensory element having at least two states and the sensory modules are configured for bringing the at least one sensory element into one of its states in response to the pixelated signal.

### BACKGROUND OF THE INVENTION

1. Field of the Invention

The present invention relates to the electrical arts. In particular, it relates to a system for projecting sensory elements and a method for using the system.

2. Description of the Related Art

Audiences at concerts and sporting events and the like have come to expect more and more from their concert experiences. They not only want to see and hear a performance, but they want to be part of it. For example, audiences thrill when the spot line is turned on them or when they can be part of a card section or when they can show their appreciation by lighting a cigarette lighter.

U.S. Patent Publication describes a method for extending the audience participation experience. Members of an audience are equipped with lighting modules which are individually tracked, for example, using RF technology such as Wi-Fi, Zigbee or Bluetooth. The lighting modules form a network receiving data from a transmission unit. The data corresponds to an image to be displayed depending on the determined position of the light modules in the network. Drawbacks to such RF-based methods include limitations on the bandwidth of the RF signal, limitations on the number of devices that can be included in the network and interference by physical objects.

### SUMMARY OF THE INVENTION

Now there has been discovered a system and method that overcomes these limitations and provides additional related advantages. An aspect of the invention is a sensory element transmission system that includes an electromagnetic signal projector configured to project a pixelated signal across a projection field and a plurality of individual sensory modules, where each sensory module includes at least one sensory element having at least two states and where the sensory modules are configured to bring the at least one sensory element into one of its states in response to the pixelated signal.

In some embodiments, the electromagnetic signal projector comprises a transmitter configured to project a pixelated signal and an electromagnetic signal projector controller configured to control the transmitter. In one aspect, the transmitter is an infrasonic wave transmitter, an acoustic wave transmitter, an ultrasonic wave transmitter, an infrared light transmitter or a visible light transmitter. In another aspect, the transmitter is an infrared light transmitter or a visible light transmitter. In still another aspect, the transmitter is a visible light transmitter and the electromagnetic signal projector further comprises an infrared light filter configured to filter the light projected by the visible light generator.

In some aspects, the electromagnetic signal projector is configured to project the pixelated signal across the projection field in a pattern. In some aspects, the pixelated signal is a pixelated electromagnetic beam. In some embodiments, the electromagnetic signal projector is configured to scan the electromagnetic beam across a generally planar surface and, in some embodiments, the pattern is a row by row pattern, a spiral pattern or a pattern of concentric figures. In some other embodiments, the electromagnetic signal projector is configured to scan the electromagnetic beam across an irregular surface.

In some aspects, the sensory element is a light element, an audio element or a tactile element. In some embodiments, the sensory element is a light element comprising at least one LED. And in some embodiments, the sensory modules contain a plurality of red, green, blue and white LEDs, a plurality of RGB+W LEDs or a plurality of RGBW LEDs. And is some aspects, the sensory element is further configured to vary the intensity of at least one of the states in response to the pixilated signal.

In some embodiments, the at least one sensory module is configured to bring at least one sensory element into one of its states in response to the frequency of the pixelated signal. In other embodiments, the at least one sensory module is configured to bring at least one sensory element into one of its states in response to data embedded in the pixelated signal. And is some aspects, the sensory module comprises a receiver for receiving the pixelated signal and a processor for bringing the at least one sensory module into one of its states in response to the pixelated signal.

In one aspect, at least one of the plurality of modules is adapted to be carried or worn by a person. In some embodiments, at least one of the plurality of sensory modules is adapted to be worn on a person's head, around a person's wrist or around a person's forearm. And in some embodiments, at least one of the plurality of modules is incorporated in a stick, a hat, a wrist band, an arm band, a bag or a backpack. And in still other embodiments, at least one of the plurality of modules is a smart phone. In another aspect, at least one of the plurality of modules is incorporated in an object having a fixed position in the projection field. In some embodiments, the object is incorporated in a seat, an aisle, a set or scenery.

In one aspect, the sensory element transmission system further includes an electronic media source configured to supply an electronic sensory pattern file to the electromagnetic signal projector. In some aspects, the sensory pattern files correspond to sensory patterns such as visual patterns, including still images and video (moving) images, audio patterns, including single sounds and series of sounds, such as songs and portions of songs, and tactile patterns, including vibration, pressure and temperature patterns.

In some embodiments, the electronic media source comprises a processor configured to read the sensory pattern file sent from the electronic media source, to drive a sensory pattern converter configured to convert the sensory pattern files into the pixelated signals based the position of each of the pixelated signals in the projection field, and to drive a field formatter configured to encode sensory signal data into the electromagnetic signal.

In an aspect, the electronic media source comprises a processor configured to read the sensory pattern file sent from the electronic media source, to drive a sensory pattern converter configured to convert the sensory pattern files into the pixelated signals based the position of each of the pixelated signals in the projection field, and to drive a field formatter configured to encode sensory signal data into the electromagnetic signal. And in an aspect, the processor comprises an embedded web server configured to provide a network interface for remote configuration and control of the electronic media source via the Internet. In a further aspect, the embedded web server is configured to provide a network interface for receiving sensory pattern files.

Another aspect is a method including the steps of transmitting a pixelated signal across a projection field to a plurality of individual sensory modules, where each of the sensory modules comprises at least one sensory element having at least two states, receiving the transmitted pixelated signal on the plurality of sensory modules and bringing the plurality of sensory modules into one of their states in response to the pixelated signal.

In some embodiments, the projection field is at least a portion of a stadium, a theatre, a hall, or a conference room. In some embodiments, the electromagnetic signal projector is positioned above the projection field and, in some embodiments, the electromagnetic signal projector is positioned alongside the projection field.

In some aspects, the electromagnetic signal projector projects the pixelated signal across the projection field in a sensory pattern. In some aspects, the pattern of sensory elements is a visual pattern, an audio pattern or a tactile pattern. In some aspects, the pattern of sensory elements is a still image, a video image, a single sound, a series of sounds, a vibration pattern, a pressure pattern or a temperature pattern.

In some embodiments, the pixelated signal has an infrasonic wavelength, an acoustic wavelength, an ultrasonic wavelength, an infrared light wavelength or a visible light wavelength. And in some embodiments, the pixelated signal has an infrared light wavelength obtained by placing an infrared light filter over the visible light signal produced by a visible light transmitter.

In one aspect, the pixelated signal is a broadcast by the electromagnetic signal projector over the projection field. In another aspect, the pixelated signal is a pixelated electromagnetic beam. In some embodiments, the electromagnetic beam across is scanned across a generally planar surface and, in some embodiments, the electromagnetic beam is scanned in a row by row pattern, a spiral pattern or a pattern of concentric figures. In some other embodiments, the electromagnetic beam is scanned across an irregular surface.

In some aspects, the pixelated signal is refreshed. In some embodiments, the pixelated signal is refreshed at a rate greater than about ten field scans per second and, in some embodiments, the pixelated signal is refreshed at a rate greater than about twenty five field scans per second.

In some aspects, the sensory element is a light element, an audio element or a tactile element or combinations thereof. In some embodiments, the sensory element is a light element comprising at least one LED. And in some embodiments, the sensory modules contain a plurality of red, green, blue and white LEDs, a plurality of RGB+W LEDs or a plurality of RGBW LEDs. And is some aspects, the sensory element varies the intensity of at least one of the states in response to the pixilated signal.

In some embodiments, the plurality of sensory modules brings at least a portion of the plurality of sensory elements into one of their states in response to the frequency of the pixelated signal. In other embodiments, the plurality of sensory modules brings at least a portion of the plurality of sensory elements into one of their states in response to data embedded in the pixelated signal.

In one aspect, at least one of the plurality of modules is carried or worn by a person. In some embodiments, at least one of the plurality of sensory modules is worn on a person's head, around a person's wrist or around a person's forearm. And in some embodiments, at least one of the plurality of modules is incorporated in a stick, a hat, a wrist band, an arm band, a bag or a backpack. And in still other embodiments, at least one of the plurality of modules is a smart phone. In another aspect, at least one of the plurality of modules is incorporated in an object having a fixed position in the projection field. In some embodiments, the object is incorporated in a seat, an aisle, a set or scenery.

In some embodiments, an electronic sensory pattern file is sent from an electronic media source to the electromagnetic signal projector. In some other embodiments, the sensory pattern file sent from the electronic media source is read by an electromagnetic signal projector processor, then converted into pixelated signals based on the location of each of the pixelated signals in the projection field by a converter and then sensory signal data is encoded into the pixelated signal.

In an aspect, the electronic media source is remotely configured and controlled via the Internet. And in an aspect, the sensory pattern file is received via the Internet.

### BRIEF DESCRIPTION OF THE DRAWINGS

The accompanying drawings, together with the specification, illustrate exemplary embodiments, and, together with the description, serve to explain the principles of these embodiments.

FIG. 1 is a conceptual representation of a sensory element transmission system in accordance with one aspect of the invention.

FIG. 2 is a conceptual representation of a sensory element transmission system in accordance with a second aspect of the invention.

FIG. 3 is a conceptual representation of a sensory element transmission system in accordance with a third aspect of the invention.

FIG. 4 is a block diagram illustrating an electromagnetic signal projector in accordance with an aspect of the invention.

FIGS. 5A and 5B illustrate alternate scanning patterns in accordance with alternative aspects of the invention.

FIG. 6 is a block diagram illustrating a sensory module in accordance with an aspect of the invention.

FIG. 7 is a block diagram illustrating an electronic media source in accordance with an aspect of the invention.

### DETAILED DESCRIPTION OF THE PREFERRED EMBODIMENTS

Particular embodiments of the invention are described below in detail for the purpose of illustrating its principles and operation. However, various modifications may be made and the scope of the invention is not limited to the exemplary embodiments described below.

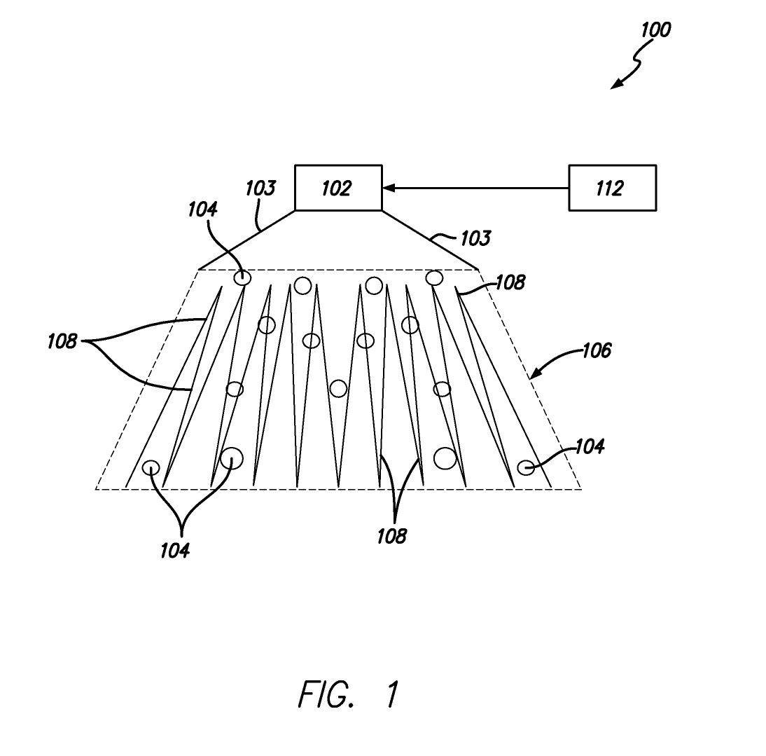

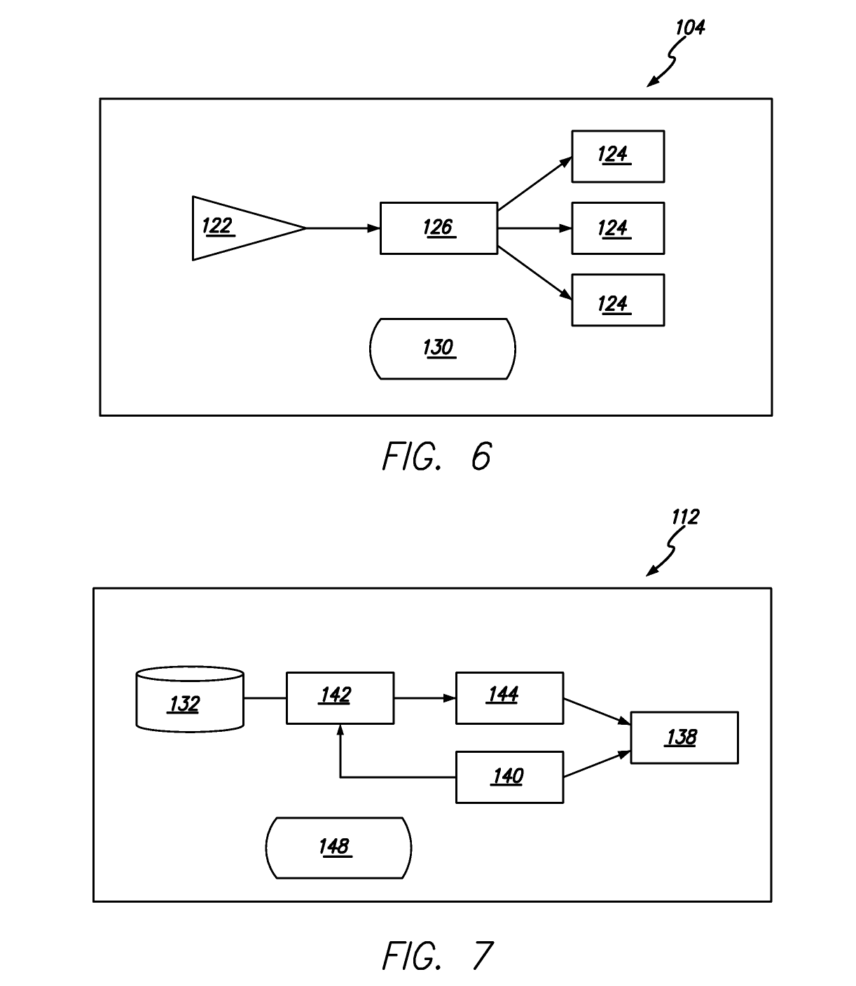

FIG. 1 is a conceptual representation of a sensory element transmission system 100 in accordance with an aspect of the invention. The sensory element transmission system includes an electromagnetic signal projector 102 and a plurality of individual sensory modules 104 located in a projection field 106. The electromagnetic signal projector is configured to project an electromagnetic signal 103 across the projection field to the plurality of individual sensory modules. Each sensory module includes at least one sensory element 124 (FIG. 6) having at least two states and each sensory module is configured to bring the at least one sensory element into one of its states in response to the electromagnetic signal.

In context of this specification and claims a “pixelated signal” is an electromagnetic signal that has been broken up in to discrete portions, so that discrete portions of the electromagnetic signal are received by on or more individual sensory elements, enabling the individual sensory elements to form a pattern corresponding to the discrete portions on the projection field.

In one aspect, the sensory element transmission system 100 additionally includes a media source 112 including without limitation, an electronic media source, such as a digital media source and the like.

In some aspects, the electromagnetic signal projector is configured to project the pixelated signal across the projection field in a sensory pattern. Representative sensory patterns include visual, audio and tactile patterns and combination thereof. Visual patterns include, without limitation, still images and video (moving) images. Audio patterns include, without limitation, single sounds and series of sounds, such as songs and portions of songs. Tactile patterns include, without limitation vibration, pressure and temperature. And in some embodiments, the sensor module is further configured to vary the intensity of at least one state in response to the pixilated signal.

In some aspects, the projection field 106 can be all or part of a theatre, a concert hall, a sports arena, an exhibition hall, a conference room or the like. In one aspect, the projection field encompasses at least a portion of the area occupied by the audience. For example, in some embodiments, the projection field is a generally planar surface, such as the ground or floor filled with seats or by a standing audience or at least a portion of a stage or area occupied by the performer, speaker or athlete. In other embodiments, the surface is an irregular surface, such as the surface formed by the floor and balconies of a theater or arena.

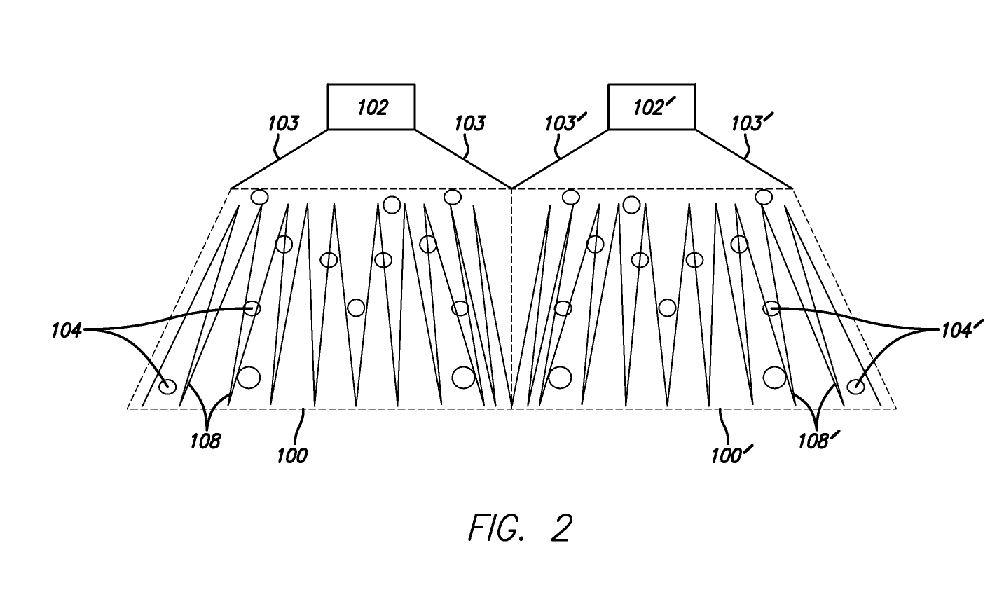

In the representative embodiment shown in FIG. 1, a single electromagnetic signal projector 102 is positioned above the projection field 106. However, it is a distinct advantage of the invention that one or more electromagnetic signal projectors can be used and the projectors can be positioned in different areas. The number and placement of the electromagnetic signal projectors can readily be determined by one skilled in the art based on the size and the dimensions, as well as the nature, of the sensory pattern(s) to be projected, limited only by the requirement that there be a relatively clear line of sight between the electromagnetic signal projector and the sensory modules 104.

Where the sensory pattern is large or odd shaped, two or more electromagnetic signal projectors can be positioned above projection field. For example, in the representative embodiment shown in FIG. 2, two electromagnetic signal projectors 102 and 102′ are positioned above two adjacent projection fields 106 and 106′.

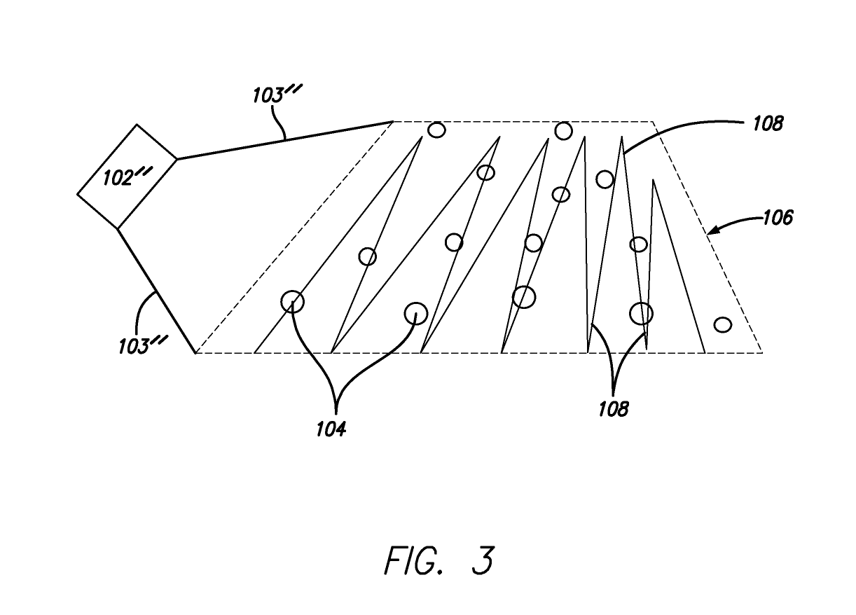

In the representative embodiment shown in FIG. 3, an electromagnetic signal projector 102″ is positioned along the side of the field 106″. Thus it is possible to project a sensory pattern or patterns onto the projection field from any angle.

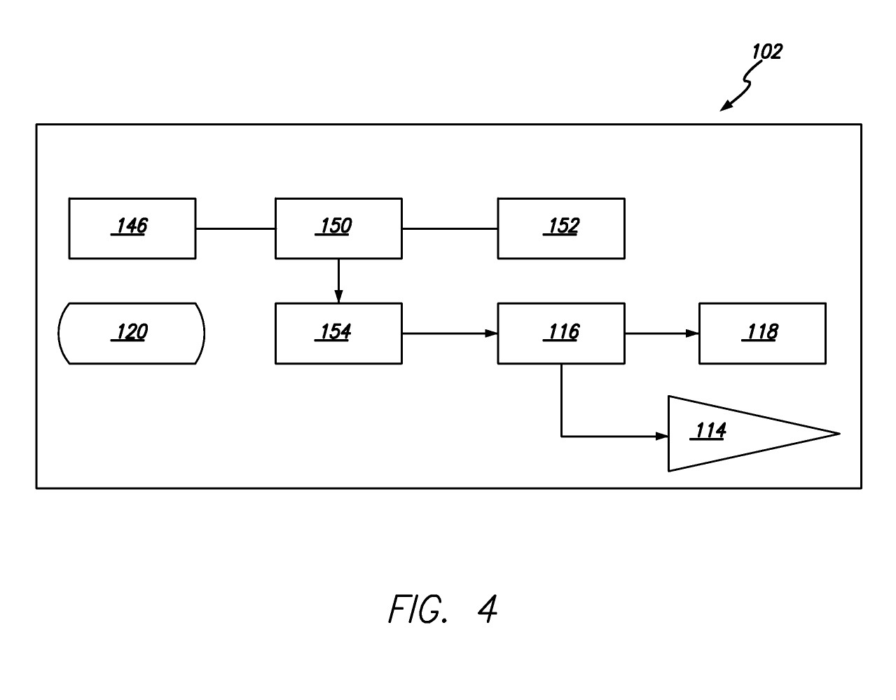

Shown in FIG. 4 is a block diagram of a representative embodiment of an electromagnetic signal projector 102 in accordance with the invention. The electromagnetic signal projector includes a transmitter 114 and an electromagnetic signal projector controller 116 configured to control the transmitter.

In one aspect the electromagnetic signal projector 102 is configured to project a pixelated signal of any suitable wavelength. i.e., wavelengths that are not damaging for the human body or brain. Representative transmitters, include without limitation, infrasonic transmitters for projecting infrasonic waves (wavelength>17 m), acoustic transmitters for projecting sonic waves (wavelength 17 m-1.7 cm), ultrasonic transmitters for projecting ultrasonic waves (wavelength<1.7 cm), infrared light transmitters, including infrared laser transmitters, for projecting infrared light (wavelength 750 nm-1 mm) and visible light transmitters, including visible light lasers, for projecting visible light. In some aspects, combinations of transmitters and filters are used to produce the desired electromagnetic signal. For example, in some embodiments, an infrared light filter is used with a visible light to produce an infrared light signal.

In one aspect, the electromagnetic signal projector 102 is configured to broadcast the pixelated signal over the projection field. In another aspect, the electromagnetic signal projector is configured to focus the pixelated signal to create a relatively narrow, straight pixelated electromagnetic beam. And in one aspect, the electromagnetic signal projector is configured to scan the pixelated beam across the projection field.

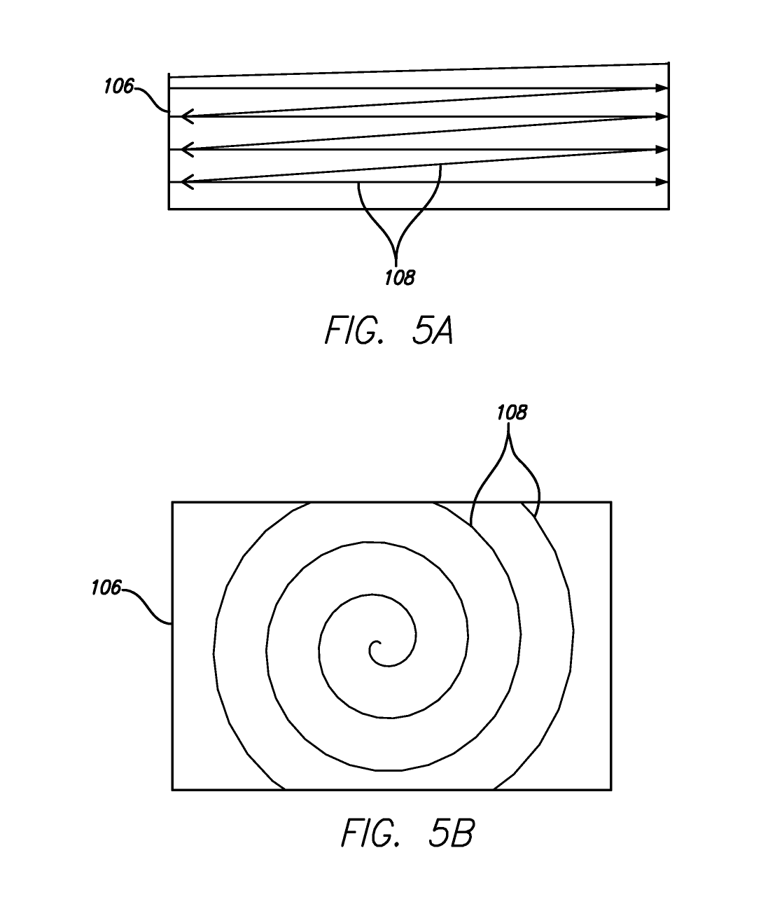

In some aspects, the pixilated beam is scanned across the projection field to project the pixelated electromagnetic beam in a specific sensory pattern. In some aspects, the sensory pattern is designed to be projected on to a generally planar surface. For example, in the representative embodiment shown in FIG. 5A, the beam is scanned in a row by row pattern. In the representative embodiment shown, in FIG. 5B, the beam is scanned in a spiral pattern. In other embodiments, the beam can be scanned in a pattern of concentric figures or the like. In other aspects, the sensory pattern is design to be projected on to curved or irregular surface.

In some aspects, the electromagnetic signal projector 102 further includes an electromagnetic signal projector motor 118, controllable by the electromagnetic signal projector controller 116. The electromagnetic signal projector motor is configured to orient the electromagnetic signal projector. In some further aspects, the electromagnetic signal projector contains an electromagnetic signal projector power supply 120.

Shown in FIG. 6 is a block diagram of a representative embodiment of a sensory module 104 in accordance with the invention. In some aspects, the sensory module includes a receiver 122 for receiving the pixelated signal from the electromagnetic signal projector. A processor 126 is included in the sensory module for processing the received signal and translating the signal into the appropriate output format for the sensory element.

In the representative embodiment shown in FIG. 6, the sensory module contains three sensory elements 124. However, in other embodiments, the sensory module can contain one or more sensory elements which can be the same or different. Representative sensory elements include light elements for emitting light, audio elements for producing sound and tactile elements, such as vibrating, pressure or temperature elements, for creating tactile sensations and combination thereof.

In some embodiments, the sensory modules include at least one LED. In some embodiments, the sensory modules contain a plurality of red, green, blue and white LEDs, while in some embodiments the sensory modules contain a plurality of RGB+W LEDs, and in some embodiments the sensory module contain a plurality of RGBW LEDs. With such embodiments, multi-color images can be shown. Alternatively, the sensory modules are monochrome modules, in which case “black and white” (depending on the color of light emitted by the modules) or binary images may be shown. In embodiments where the sensory module contains a plurality of light elements, video (moving) images can be shown on the sensory module. The images shown may be patterns, for example moving patterns.

Tactile elements can be any suitable element. Representative elements include vibration motors, heat pads, piezo elements and the like.

In some embodiments, the sensory module 104 includes a battery 130, such as an electrochemical or motion-charged battery, so that the sensory module is self-powered. In other embodiments, the sensory module is powered using at least one solar panel.

In some aspects, the sensory module 104 is a dedicated device included in an item adapted to be worn or carried by persons located in the projection field. For, example, in some embodiments, the sensory module is included in an item adapted to be worn by a person, such as an audience member or performer. Such items include items adapted to be worn on or around a person's head, around a person's wrist, around a person's forearm, or other items of clothing and include hats, headphones, earphones, wrist bands, arm bands, and the like. In alternative embodiments, the sensory module is a dedicated device included in an item adapted to be carried by a person, such as an audience member or performer. Such items include sticks, bags, backpacks, cups, props or the like. In another aspect, the sensory module is a dedicated device included seats, aisles, set, scenery and other fixed locations in the projection field. In another aspect, each of the plurality of modules is a smart phone configured to receive the pixelated signal and run a software application to translate the pixelated signal into the desired output, i.e., to produce one or more light elements, sound elements and tactile elements.

Shown in FIG. 7 is a block diagram of a representative embodiment of an electronic media source 112 configured to supply an electronic sensory pattern file to the electromagnetic signal projector 102. In some embodiments of the present invention, the sensory pattern file is a digital representation of an image or series of images, or a digital representation of a sound or series of sounds, stored in memory or on a storage device 132 such as an optical disk, solid state memory, tape or magnetic disk. In alternative embodiments, the processor 142 includes an embedded web server configured to provide a network interface for receiving electronic sensory pattern files via the Internet.

In some aspects, the sensory pattern files correspond to sensory patterns such as visual patterns, including still images and video (moving) streams, audio patterns, including single sounds and audio streams, such as songs and portions of songs and tactile patterns, including vibration, pressure and temperature patterns. An electronic media source processor 140 reads the sensory pattern files and sends them to a publisher which then sends the files to the electromagnetic signal projector.

In alternative embodiments, at least on sensory module 104 is preloaded with one or more video streams or audio streams. In such embodiments, the at least one sensory module is provided with memory means for storing the preloaded one or more video streams or audio streams.

The electronic media source 112 is operably connected to the electromagnetic signal projector 102 by any suitable method. For example, the connection can be either wired or wireless. In the representative embodiment shown in FIG. 7, the electronic media source 112 contains an internet protocol connector 138 to permit wireless communication with external systems. In such an aspect, a controller 140 is configured to receive control commands from an external system. In some such embodiments, the embedded web server is further configured to provide a network interface for remote configuration and control of the electronic media source via the Internet.

In the representative embodiment shown in FIG. 7, a processor 142 reads the sensory pattern files requested from an external system and then sends the files to a publisher 144 which sends the files to the electronic signal projector 102.

In some embodiments, the electronic media source is an integral component of the electromagnetic signal projector. In the representative embodiment shown in FIG. 7, the electronic media source 112 is an external system. In those embodiments where the electronic media source is an external system, it can be operably connected to the electromagnetic signal projector in any suitable matter, such as by a wireless connection. In the exemplary embodiment shown in FIGS. 4 and 7 an Internet Protocol (IP) connection is made between an IP connector 146 in the electromagnetic signal projector 102 and the IP connector 138 in the electronic media source.

In the representative embodiment shown in FIG. 5, a processor 150 is configured to read the sensory pattern file sent from the electronic media source 112 and drive sensory pattern converter 152 and field formatter 154. The sensory pattern converter is configured to convert the files into pixelated signals, i.e., the sensory pattern converter is configured to break the electromagnetic signal into discrete chunks, to be projected on the projection field based on a location in the projection field. The field formatter encodes sensory signal data into the pixelated signal. In some aspects, the data is the pixelated signal itself. In other aspects, the field formatter embeds data in the pixelated signal.

Turning now to the method of operation, in one aspect, a pattern of sensory elements is created using a plurality of sensory modules located in a projection field. A pixelated signal is transmitted across the projection field containing the plurality of individual sensory modules. In some aspects, each of the sensory modules includes at least one sensory element having at least two states. The transmitted pixelated signal is received by the plurality of sensory modules and the plurality of sensory elements are brought into one of their states in response to the pixelated signal to create a sensory pattern.

It is an advantage of the inventive method that it is of use in a wide variety of environments. In some embodiments, the projection field is at least a portion of a stadium, a theatre, a hall, or a conference room. As shown in FIGS. 1 and 2, in some embodiments the pixelated signal is transmitted from an electromagnetic signal projector positioned above the projection field. As shown in FIG. 3, in some embodiments, the pixelated signal is transmitted from an electromagnetic signal projector positioned alongside the projection field.

Another distinct advantage of the inventive method, that it can be used to create a wide variety of sensory patterns. In some embodiments, the pattern of sensory elements is a visual pattern, an audio pattern or a tactile pattern. And in some embodiments, the pattern of sensory elements is a still image, a video image, a single sound, a series of sounds, a vibration pattern, a pressure pattern or a temperature pattern. In some aspects, the sensory element is further configured to vary the intensity of at least one of the states in responses to the pixilated signal.

Any suitable wavelength. i.e., any wavelength that is not damaging for the human body or brain can be used in the method in accordance with the invention. In some representative embodiments, the pixelated signal has an infrasonic wavelength, an acoustic wavelength, an ultrasonic wavelength, an infrared light wavelength, or a visible light wavelength. And in some embodiments, the pixelated signal has an infrared light wavelength obtained by placing an infrared light filter over the visible light signal produced by a visible light transmitter.

In one aspect, the electromagnetic signal projector broadcasts the pixelated signal over the projection field. In another aspect, the electromagnetic signal projector focuses the pixelated signal to create a relatively narrow, straight pixelated electromagnetic beam. And in one aspect, the electromagnetic signal projector scans the pixelated beam across the projection field.

In some embodiments, the pixilated beam is scanned across the projection field to project the pixelated electromagnetic beam in a specific sensory pattern. In some aspects, the sensory pattern is designed to be projected on to a generally planar surface. For example, in the representative embodiment shown in FIG. 5A, the beam is scanned in a row by row pattern. And in the representative embodiment shown in FIG. 5B, the beam is scanned in a spiral pattern. In other embodiments, the beam can be scanned in a pattern of concentric figures or the like. In other aspects, the pattern is designed to be projected on to an irregular surface, such as a surface formed by both the floor and balconies of a theatre or arena.

In some aspects, the pixelated signal is refreshed. In some embodiments, the pixelated signal is refreshed at a rate greater than about ten field scans per second and, in some embodiments, the pixelated signal is refreshed at a rate greater than about twenty five field scans per second.

It is yet another advantage of the inventive method that it is of use with a wide variety of sensory elements. In representative embodiments, the sensory element is a light element, an audio element, a tactile element or combinations thereof. In some embodiments, the sensory element is a light element comprising at least one LED. In some embodiments, the sensory modules contain a plurality of red, green, blue and white LEDs, while in some embodiments the sensory modules contain a plurality of RGB+W LEDs, and in some embodiments the sensory module contain a plurality of RGBW LEDs.

In some embodiments, at least one sensory module brings at least one sensory element into one of its states in response to the frequency of the pixelated signal. In other embodiments, at least one sensory module brings at least one sensory element into one of its states in response to data embedded in the pixelated signal. In an aspect, at least one of the plurality of modules is worn on a person's head, around a person's wrist or around a person's forearm. In another aspect, at least one of the plurality of modules is incorporated in a stick, a hat, a wrist band, an arm band, a bag or a backpack. And in still another aspect, at least one of the plurality of modules is a smart phone that receives the pixelated signal and runs a software application to translate the pixelated signal into the desired output, i.e., to produce one or more light elements, sound elements and tactile elements. In some embodiments, the sensory module is incorporated in seats, aisles, set, scenery or other fixed locations in the projection field.

In some embodiments, an electronic sensory pattern file is sent from the electronic media source to the electromagnetic signal projector. And in some embodiments, the sensory pattern file sent from the electronic media source is read by an electromagnetic signal projector processor, the sensory pattern files then converted into pixelated signals based the location of each of the pixelated signals in the projection field by a converter and then sensory signal data encoded into the pixelated signal.

In the foregoing specification, various aspects of the invention have been described with reference to specific exemplary embodiments. Various modifications and changes may be made, however, without departing from the scope of the present invention. The specification and figures are illustrative, rather than restrictive, and modifications are intended to be included within the scope of the present invention. Accordingly, the scope of the invention should be determined by the claims and their legal equivalents rather than by merely the examples described. With regard to particular embodiments described above, any benefit, advantage, solution to a problem, or any element that may cause any particular benefit, advantage, or solution to occur or to become more pronounced are not to be construed as critical, required, or essential features or components of any or all the claims.

As used herein, the terms “comprise,” “comprises,” “comprising,” “having,” “including,” “includes” or any variation thereof, are intended to reference a non-exclusive inclusion, such that a process, method, article, composition or apparatus that comprises a list of elements does not include only those elements recited, but may also include other elements not expressly listed or inherent to such process, method, article, composition, or apparatus. Other combinations and/or modifications of the above-described structures, arrangements, applications, proportions, elements, materials, or components used in the practice of the present invention, in addition to those not specifically recited, may be varied or otherwise particularly adapted to specific environments, manufacturing specifications, design parameters, or other operating requirements without departing from the general principles of the same.

We claim:

1. A sensory element projection system comprising:
an electromagnetic signal projector configured to project a pixelated signal across a projection field and
a plurality of individual sensory modules, each sensory module comprising at least one sensory element having at least two states, the sensory modules configured for bringing the at least one sensory element into one of its states in response to the pixelated signal.

2. The sensory element projection system of claim 1 wherein the electromagnetic signal projector comprises a transmitter configured to project the pixelated signal and an electromagnetic signal projector controller configured to control the transmitter.

3. The sensory element projection system of claim 2 wherein the transmitter is an infrasonic wave transmitter, an acoustic wave transmitter, an ultrasonic wave transmitter, an infrared light transmitter, or a visible light transmitter.

4. The sensory element projection system of claim 3 wherein the transmitter is an infrared light transmitter or a visible light transmitter.

5. The sensory element projection system of claim 4 wherein the transmitter is a visible light transmitter and further comprising an infrared light filter configured to filter the light projected by the visible light transmitter.

6. The sensory element projection system of claim 1 wherein the electromagnetic signal projector is configured to project the pixelated signal across the projection field in a sensory pattern.

7. The sensory element projection system of claim 6 wherein the pixelated signal is a pixelated electromagnetic beam.

8. The sensory element projection system of claim 7 wherein the electromagnetic signal projector is configured to scan the electromagnetic beam across a generally planar surface.

9. The sensory element projection system of claim 7 wherein the sensory pattern is a row by row pattern, a spiral pattern or a pattern of concentric figures.

10. The sensory element projection system of claim 7 wherein the electromagnetic signal projector is configured to scan the electromagnetic beam across an irregular surface.

11. The sensory element projection system of claim 1 wherein the sensory element is a light element, an audio element, a tactile element or a combination thereof.

12. The sensory element projection system of claim 1 wherein the sensory element is further configured to vary the intensity of at least one of the states in response to the pixilated signal.

13. The sensory element projection system of claim 12 wherein the sensory element is a light element.

14. The sensory element projection system of claim 13 wherein the light element comprises at least one LED.

15. The sensory element projection system of claim 14 wherein the sensory modules contain a plurality of red, green, blue and white LEDs, a plurality of RGB+W LEDs or a plurality of RGBW LEDs.

16. The sensory element projection system of claim 1 wherein at least one sensory module is configured to bring at least one sensory element into one of its states in response to the frequency of the pixelated signal.

17. The sensory element projection system of claim 1 wherein at least one sensory module is configured to bring at least one sensory element into one of its states in response to data embedded in the pixelated signal.

18. The sensory element projection system of claim 1 wherein the sensory module comprises a receiver for receiving the pixelated signal and a processor for bringing the at least one sensory module into one of its states in response to the pixelated signal.

19. The sensory element projection system of claim 1 wherein at least one of the plurality of modules is adapted to be carried or worn by a person.

20. The sensory element projection system of claim 19 wherein at least one of the plurality of modules is incorporated in a stick, a hat, a wrist band, an arm band, a bag or a backpack.

21. The sensory element projection system of claim 19 wherein at least one of the plurality of modules is a smart phone.

22. The sensory element projection system of claim 1 wherein at least one of the plurality of modules is incorporated in an object having a fixed position in the projection field.

23. The sensory element projection system of claim 22 wherein the object is incorporated in a seat, an aisle, a set or scenery.

24. The sensory element projection system of claim 6 further comprising an electronic media source configured to supply an electronic sensory pattern file to the electromagnetic signal projector.

25. The sensory element projection system of claim 24 wherein the electronic sensory pattern file corresponds to a visual pattern, an audio pattern, a tactile pattern or a combination thereof.

26. The sensory element projection system of claim 25 wherein the electronic sensory pattern file corresponds to a still image, a video image, a single sound, a series of sounds, a vibration pattern, a pressure pattern or a temperature pattern or a combination thereof.

27. The sensory element projection system of claim 24 wherein the electronic media source comprises a processor configured to read the sensory pattern file sent from the electronic media source, to drive a sensory pattern converter configured to convert the sensory pattern files into the pixelated signals based on the position of each of the pixelated signals in the projection field and to drive a field formatter configured to encode sensory signal data into the electromagnetic signal.

28. The sensory element projection system of claim 27 wherein the processor comprises an embedded web server configured to provide a network interface for remote configuration and control of the electronic media source via the internet.

29. The sensory element projection system of claim 28 wherein the embedded web server is further configured to provide a network interface for receiving sensory pattern files.

30. A method for projecting electromagnetic signals onto a projection field comprising the steps of:
transmitting a pixelated signal across a projection field to a plurality of individual sensory modules, each of the sensory modules comprising at least one sensory element having at least two states;
receiving the transmitted pixelated signal on the plurality of sensory modules; and
bringing the at least one sensory elements on the plurality of sensor modules into one of their states in response to the pixelated signal.

31. The method of claim 30 wherein the projection field contains a plurality persons and wherein each of the individual sensory modules is carried or worn by one of the persons.

32. The method of claim 30 wherein the electromagnetic signal projector is positioned above the projection field.

33. The method of claim 30 wherein the electromagnetic signal projector is positioned along side the projection field.

34. The method of claim 30 wherein the electromagnetic signal projector projects the pixelated signal across the projection field in a sensory pattern.

35. The method of claim 34 wherein the sensory pattern is a visual pattern, an audio pattern, a tactile pattern or a combination thereof.

36. The method of claim 30 wherein the sensory element is further configured to vary the intensity of at least one of the states in response to the pixilated signal.

37. The method of claim 34 wherein the sensory pattern is a still image, a video image, a single sound, a series of sounds, a vibration pattern, a pressure pattern, a temperature pattern or a combination thereof.

38. The method of claim 30 wherein the projection field is at least a portion of a stadium, a theatre, a hall or a conference room.

39. The method of claim 30 wherein the pixelated signal has an infrasonic wavelength, an acoustic wavelength, an ultrasonic wavelength, an infrared light wavelength or a visible light wavelength.

40. The method of claim 39 wherein the pixelated signal has an infrared light wavelength or a visible light wavelength.

41. The method of claim 40 wherein the pixelated signal has an infrared light wavelength obtained by placing an infrared light filter over a visible light signal produced by a visible light transmitter.

42. The method of claim 30 wherein the pixelated signal is broadcast over the projection field.

43. The method of claim 30 wherein the pixelated signal is a pixelated electromagnetic beam.

44. The method of claim 43 wherein the electromagnetic beam is scanned across the projection field.

45. The method of claim 44 wherein the electromagnetic beam is scanned across a generally planar surface.

46. The method of claim 45 wherein the sensory pattern is a row by row pattern, a spiral pattern or a pattern of concentric figures.

47. The method of claim 44 wherein the electromagnetic beam is scanned across an irregular surface.

48. The method of claim 30 wherein the pixelated signal is refreshed.

49. The method of claim 48 wherein the pixelated signal is refreshed at a rate greater than about ten field scans per second.

50. The method of claim 48 wherein the pixelated signal is refreshed at a rate greater than about twenty five field scans per second.

51. The method of claim 30 wherein the sensory element is a light element, an audio element, a tactile element or a combination thereof.

52. The method of claim 51 wherein the sensory element is a light element.

53. The method of claim 52 wherein the light element comprises at least one LED.

54. The method of claim 53 wherein the sensory modules contain a plurality of red, green, blue and white LEDs, a plurality of RGB+W LEDs or a plurality of RGBW LEDs.

55. The method of claim 30 wherein at least one sensory module brings at least one sensory element into one of its states in response to the frequency of the pixelated signal.

56. The method of claim 30 wherein at least one sensory module brings at least one sensory element into one of its states in response to data embedded in the pixelated signal.

57. The method of claim 31 wherein at least one of the plurality of modules is worn on a person's head, around a person's wrist or around a person's forearm.

58. The method of claim 31 wherein at least one of the plurality of modules is incorporated in a stick, a hat, a wrist band, an arm band, a bag or a backpack.

59. The method of claim 31 wherein at least one of the plurality of modules is incorporated a smart phone.

60. The method of claim 30 wherein at least one of the plurality of modules is incorporated in an object having a fixed position in the projection field.

61. The method of claim 60 wherein the object is incorporated in a seat, an aisle, a set or scenery.

62. The method of claim 34 wherein an electronic sensory pattern file is sent from a electronic media source to an electromagnetic signal projector.

63. The method of claim 62 wherein the sensory pattern file is read by an electromagnetic signal projector processor, then converted into pixelated signals based on the location of each of the pixelated signals in the projection field by a converter and then sensory signal data is encoded into the pixelated signal.

64. The method of claim 30 further comprising remotely configuring and controlling of the electronic media source via the Internet.

65. The method of claim 62 further comprising receiving the sensory pattern file via the Internet.

66. The sensory element projection system of claim 12 wherein the sensory element is an audio element.

67. The sensory element projection system of claim 12 wherein the sensory element is a tactile element.

68. The sensory element projection system of claim 67 wherein the tactile element is vibration motors, heat pads, piezo elements.

69. The method of claim 51 wherein the sensory element is a tactile element.

70. The method of claim 51 wherein the sensory element is a tactile element.

71. The method of claim 70 wherein the tactile element is a vibration motor, a heat pad, a piezo element.
